(19) United States
(12) Patent Application Publication
(10) Pub. No.: US 2015/0326762 A1
(43) Pub. Date: Nov. 12, 2015

(54) Mounts for Attaching a Motion Capture Device to a Head Mounted Display

(71) Applicant: LEAP MOTION, INC., San Francisco, CA (US)

(72) Inventors: Barry JU, San Francisco, CA (US); Kyle A. HAY, San Francisco, CA (US)

(73) Assignee: LEAP MOTION, INC., San Francisco, CA (US)

(21) Appl. No.: 14/708,184

(22) Filed: May 8, 2015

Related U.S. Application Data
(60) Provisional application No. 61/991,337, filed on May 9, 2014.

(51) Int. Cl. H04N 5/225; G02B 27/01

(52) U.S. Cl. CPC H04N 5/2252; G02B 27/0172; G02B 2027/0178

(57) ABSTRACT

The technology disclosed relates to providing devices and methods for attaching motion capture devices to head mounted displays (HMDs) using existing features of the HMDS, with no modification to the design of the HMDs. A motion capture device is attached with an adapter to a wearable device that can be a personal HMD having a goggle form factor. The motion capture device is operable to be attached to or detached from an adapter, and the adapter is operable to be attached to or detached from an HMD. The motion capture device is attached to the HMD with an adapter in a fixed position and orientation. In embodiments, the attachment mechanism coupling the adapter to the HMD utilizes existing functional or ornamental elements of an HMD. Functional or ornamental elements of the HMD include; air vents, bosses, grooves, recessed channels, slots formed where two parts connect, openings for head straps etc.

### RELATED APPLICATIONS

This application claims the benefit of U.S. Provisional Patent Application No. 61/991,337, entitled, “ADAPTER FOR ATTACHING A MOTION CAPTURE DEVICE TO A HEAD MOUNTED DISPLAY,” filed 9 May 2014 (Attorney Docket No. LEAP 1053-1). The provisional application is hereby incorporated by reference for all purposes.

This application is related to U.S. Nonprovisional patent application Ser. No. 14/708,021, entitled, “ADAPTER FOR ATTACHING A MOTION CAPTURE DEVICE TO A HEAD MOUNTED DISPLAY,” filed 8 May 2015 (Attorney Docket No. LEAP 1053-2/LPM-1053US1). The Nonprovisional application is hereby incorporated by reference for all purposes.

### FIELD OF THE TECHNOLOGY DISCLOSED

The present disclosure relates generally to attaching motion capture devices to head mounted displays and other portable devices.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

Head mounted displays (HMDs) are wearable devices that contain one or more displays positioned in the field of vision of the user wearing the device. Uses for HMDs include virtual and augmented reality applications. HMDs may include various sensors to detect motion of the HMD. The detected motion may be used as an input to a computer system providing visual data displayed by the HMD. There are HMDs that only contain sensors to detect motion of the HMD and do not contain sensors or systems capable of detecting gestures of a user.

Motion capture devices include systems for capturing image data that may be used for detecting gestures. Motion capture device may include any number of cameras and radiation emitters coupled to a sensory processing system. Motion capture device can be used for detecting gestures from a user which can be used as an input for a computer system.

A user wearing an HMD may have the desire to provide inputs to a computer system in communication with the HMD free of the encumbrances associated with contact-based input devices such as a mouse, joystick, touch pad, or touch screen, or non-contact based input devices such as a stationary motion capture device. Consequently there is a need for allowing users of HMDs and similar devices to be able to provide input to a computer system without encumbrances.

### SUMMARY

Implementations of the technology disclosed address these and other problems by providing devices and methods for attaching motion capture devices to HMDs. A motion capture device is preferably attached with an adapter to a wearable device that can be a personal head mounted display (HMD) having a goggle form factor.

In one implementation, a motion capture device is operable to be attached to or detached from an adapter, and the adapter is operable to be attached to or detached from an HMD. The motion capture device is attached to the HMD with an adapter in a fixed position and orientation. In embodiments, the attachment mechanism coupling the adapter to the HMD utilizes existing functional or ornamental elements of an HMD. Functional or ornamental elements of the HMD include; air vents, bosses, grooves, recessed channels, slots formed where two parts connect, openings for head straps, etc. Advantageously by using existing features of the HMD to attach the adapter, no modification to the design of the HMD is needed to attach a motion capture device.

Advantageously, coupling a motion capture device to an HMD with an adapter enables gesture recognition while a user is wearing an HMD. Further, implementations can provide improved interfacing with computing systems, such as using the motion capture device to detect motion of the HMD. With these advantages there is a reduced need for contact-based input devices and stationary contactless input devices.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings, in which:

FIG. 1 is a perspective view of an adapter in accordance with the technology disclosed.

FIG. 2 is a front view of an adapter in accordance with the technology disclosed.

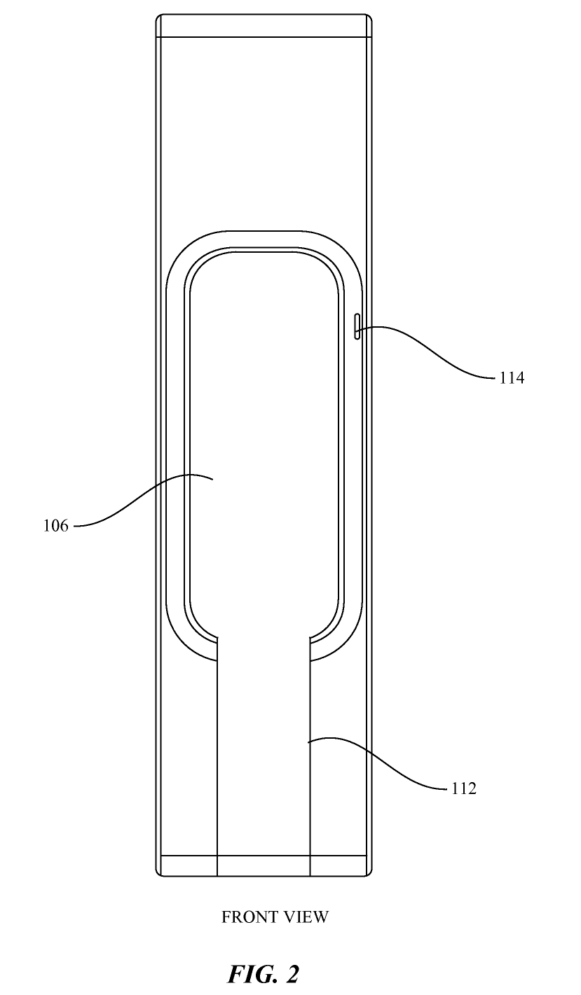

FIG. 3 is a side view of an adapter in accordance with the technology disclosed.

FIG. 4 is a rear view of an adapter in accordance with the technology disclosed.

FIG. 5 is an end view of an adapter in accordance with the technology disclosed.

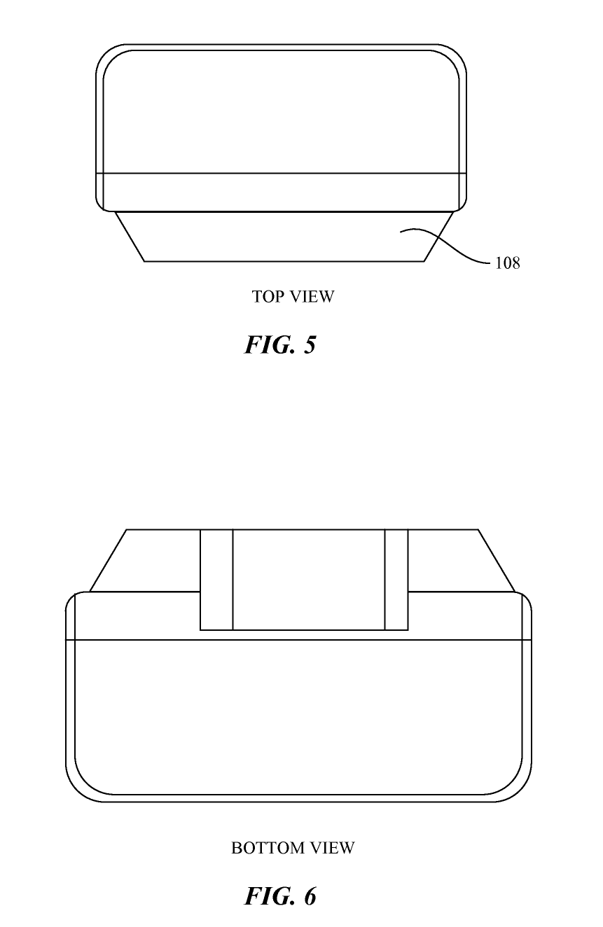

FIG. 6 is an end view of an adapter in accordance with the technology disclosed.

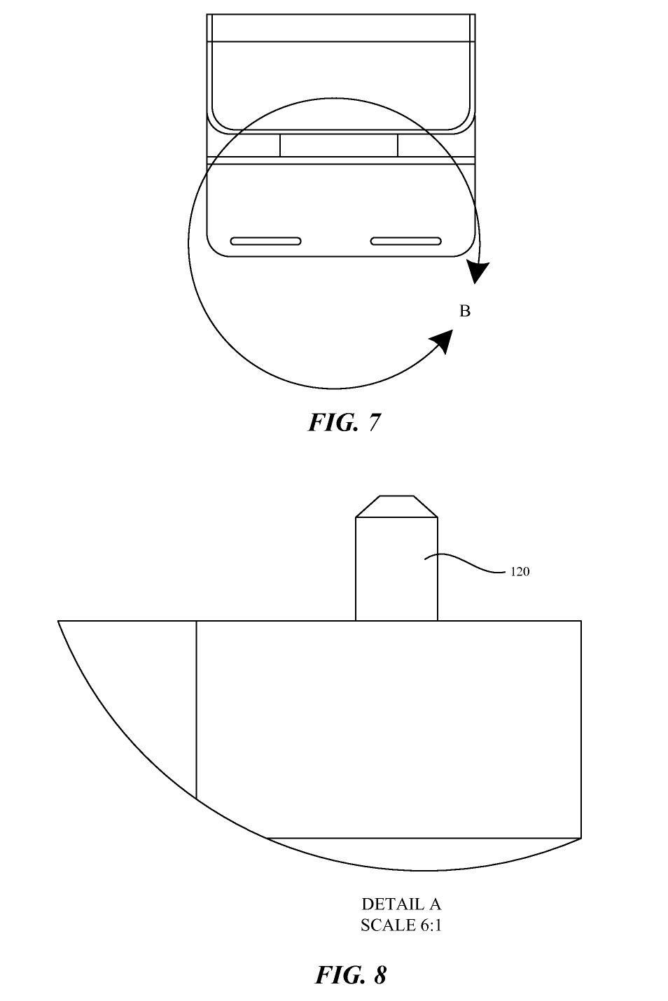

FIG. 7 is a perspective view of an adapter in accordance with the technology disclosed.

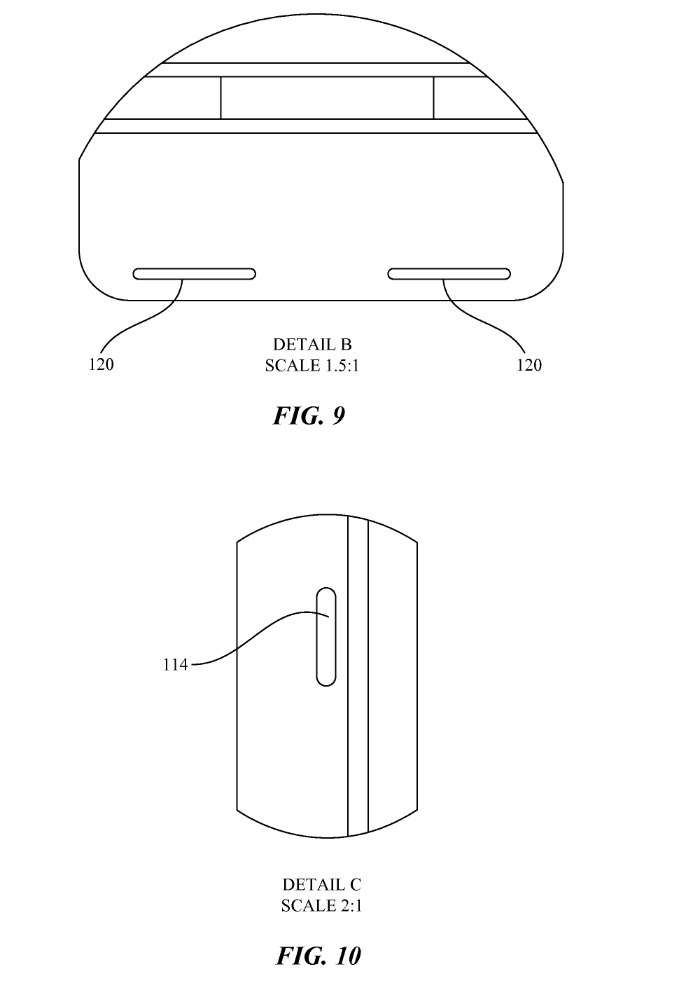

FIG. 8 is a detailed view of section A of FIG. 3.

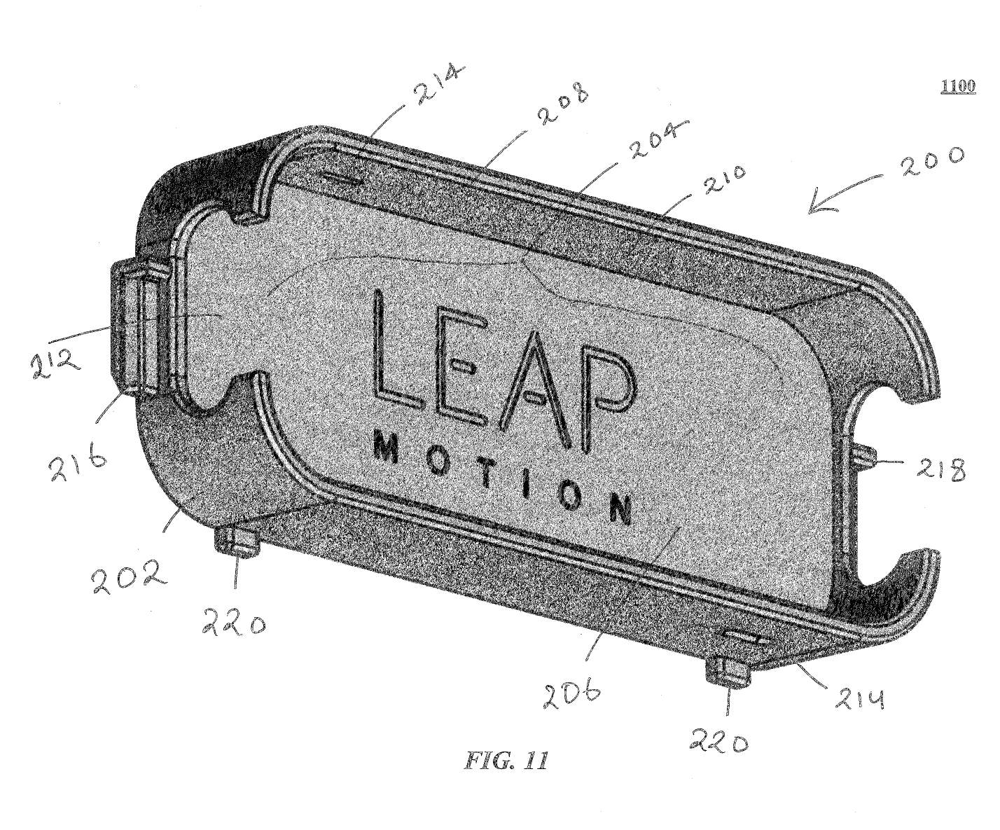

FIG. 9 is a detailed view of section B of FIG. 7.

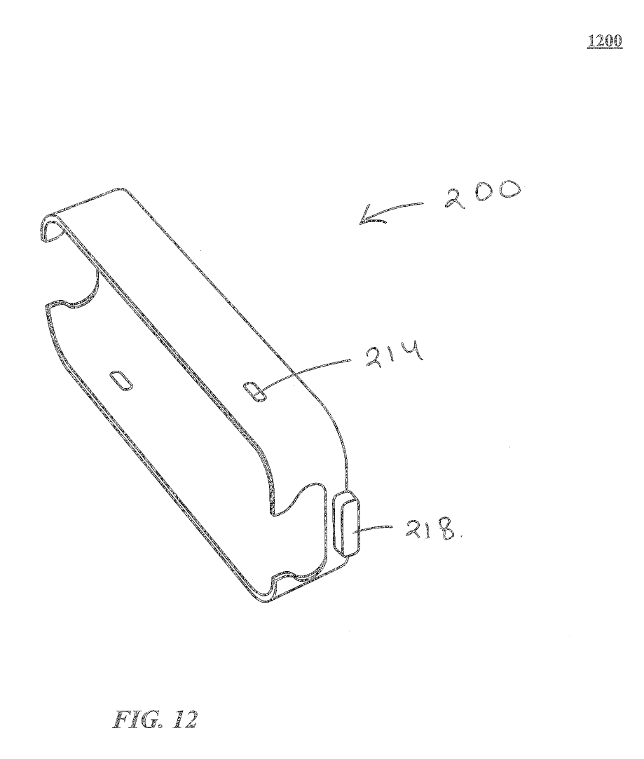

FIG. 10 is a detailed view of section C of FIG. 3.

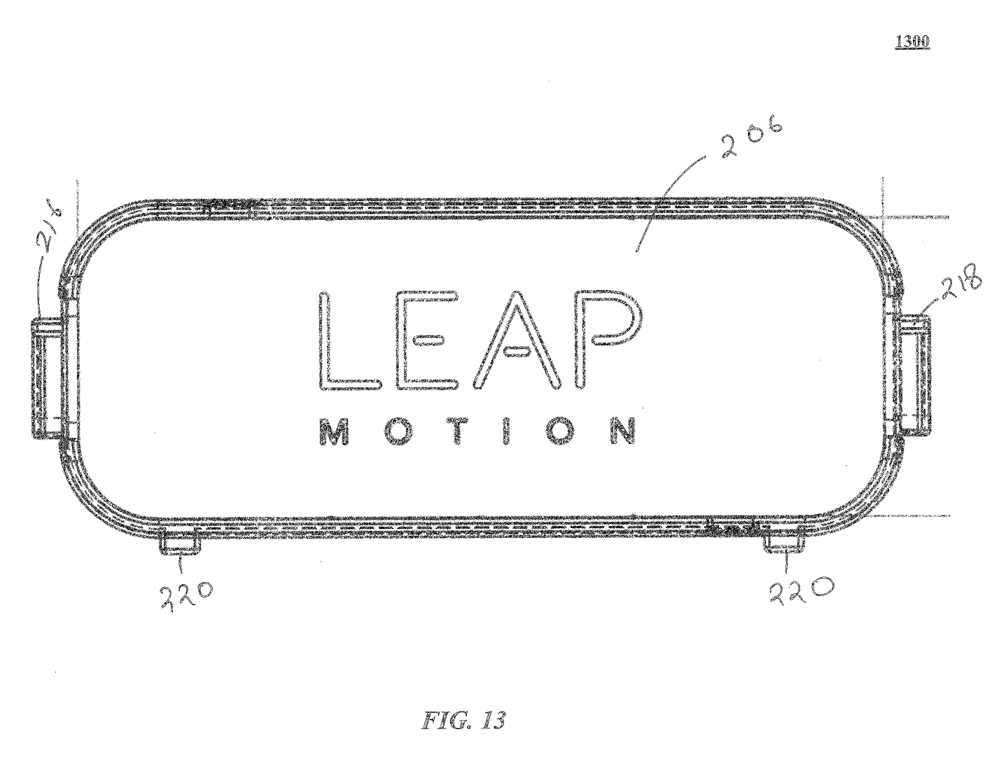

FIG. 11 is a perspective view of another implementation of an adapter in left-right orientation, in accordance with the technology disclosed.

FIG. 12 is a perspective view of the adapter shown in FIG. 11 in right-left orientation, in accordance with the technology disclosed.

FIG. 13 is a front view of the adapter shown in FIG. 11 in accordance with the technology disclosed.

FIG. 14 is a side view of the adapter shown in FIG. 11 in accordance with the technology disclosed.

FIG. 15A is a perspective view of an adapter plate, in an upright orientation, that attaches to an HMD and receives an adapter in accordance with the technology disclosed.

FIG. 15B is a perspective view of an adapter plate, in an upside down orientation, that attaches to an HMD and receives an adapter in accordance with the technology disclosed.

FIG. 16A is a front view of an adapter plate receiving an adapter in accordance with the technology disclosed.

FIG. 16B is a front view of an adapter plate attached to an adapter in accordance with the technology disclosed.

FIG. 16C is a perspective view of a motion capture device being secured in an adapter that is received by an adapter plate in accordance with the technology disclosed.

FIG. 17 is a perspective view of attaching a motion capture device to an HMD via an adapter plate and an adapter in accordance with the technology disclosed.

FIG. 18 is a perspective view of a motion capture device attached to an HMD via an adapter plate and an adapter in accordance with the technology disclosed.

FIG. 19 is a front view of a motion capture device attached to an HMD via an adapter plate and an adapter in accordance with the technology disclosed.

FIG. 20 is a perspective view of a motion capture device coupled to an HMD that enables gesture recognition while a user is wearing an HMD.

FIG. 21 is a perspective view of another implementation of an adapter attached to an HMD.

FIG. 22 is a perspective view of an adapter shown in FIG. 21.

FIG. 23 is a perspective view of a cord cover of an HMD that is replaced to attach an adapter to an HMD.

FIG. 24 is a perspective view of another implementation of an adapter used to attach a motion capture device to an HMD.

FIG. 25 is a perspective view of yet another implementation of an adapter used to attach a motion capture device to an HMD.

FIG. 26 is a perspective view of yet another implementation of an adapter used to attach a motion capture device to an HMD.

FIG. 27 is a perspective view of a motion capture device secured in an adapter shown in FIG. 26.

FIG. 28 is a perspective view of an HMD with an attached motion capture device.

FIG. 29 is a front view of an HMD with an attached motion capture device.

FIGS. 30-32 are real world images of an adapter shown in FIG. 26 that is attached to an HMD.

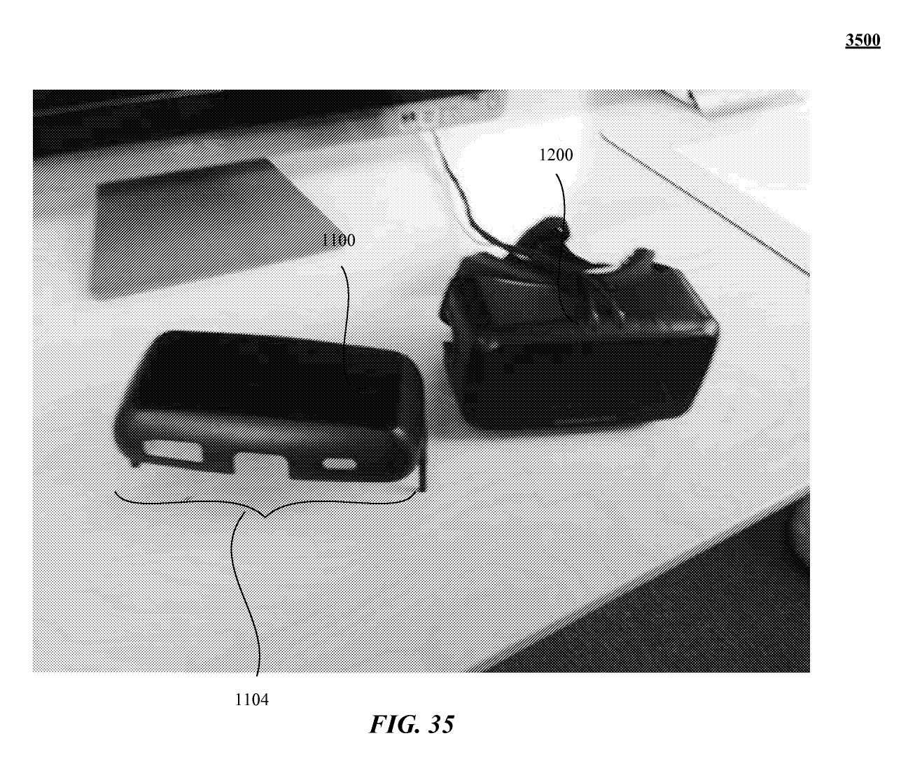

FIGS. 33-36 are real world images of yet another implementation of an adapter that is attached to an HMD.

### DETAILED DESCRIPTION

Among other aspects, the technology described herein with reference to example implementations can provide a means for attaching a motion capture device to an HMD using an adapter. Implementations can enable gesture detection, virtual reality and augmented reality, and other machine control and/or machine communications applications using portable devices, e.g., head mounted displays (HMDs), wearable goggles, watch computers, smartphones, and so forth, or mobile devices, e.g., autonomous and semi-autonomous robots.

The terminology “top”, “side”, “rear”, and “end” are used consistent with the drawings to identify respective elements of the device. It is understood that the adapter and elements of the adapter could be rotated in other orientations without going outside of the scope of the technology disclosed.

In this paper, words “adapter(s)” and “mount(s)” are used interchangeably.

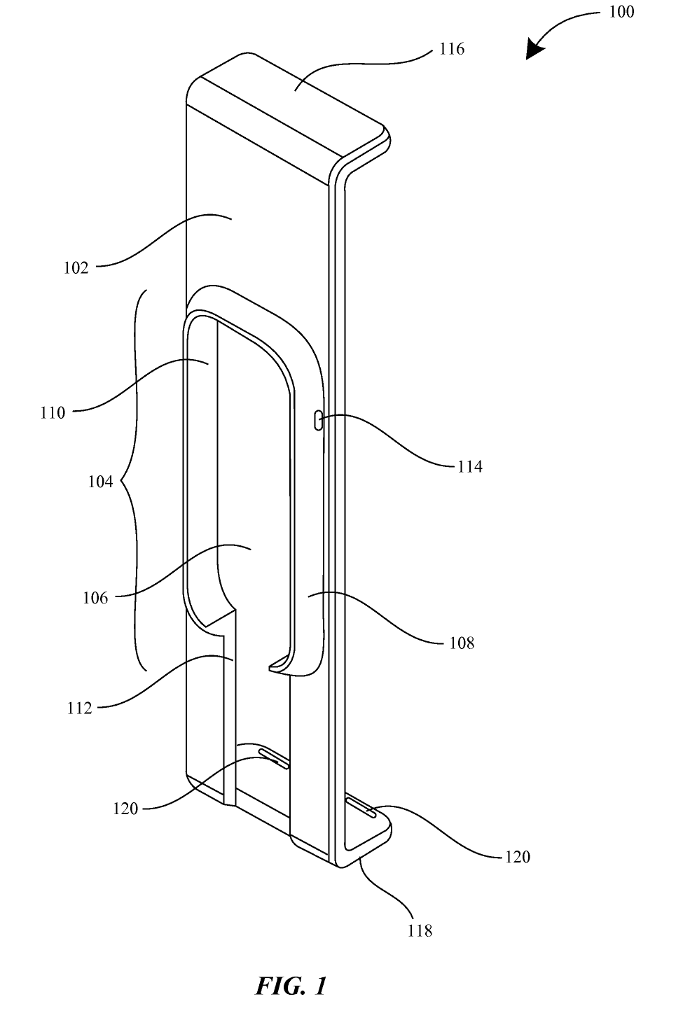

Referring to FIG. 1, an adapter 100 is illustrated. The adapter 100 includes a main body portion 102. The main body portion 102 includes a mounting portion 104 comprising an opening 106 configured to receive and secure a motion capture device. The mounting portion 104 further comprises a mounting flange 108 on the top surface of the main body located around the perimeter of the opening 106. The mounting flange 108 includes an inner surface 110 configured to provide a secure friction fit with an outer perimeter of a motion capture device creating a friction fit or compression fit. In embodiments, other attachment mechanisms for securing the motion capture device to the adapter are envisioned including magnets, clips, adhesives, etc. The mounting portion 104 may be configured to receive a motion capture device through the rear portion of the main body, the front portion of the main body or both. The mounting portion 104 may be configured to accommodate various motion capture devices with different form factors. Further the mounting portion may be configured to receive adapter plates configured to allow different motion capture devices to be attached to the adapter 100. In embodiments, the mounting portion may comprise a recess or cavity operable to selectively encapsulate a motion capture device.

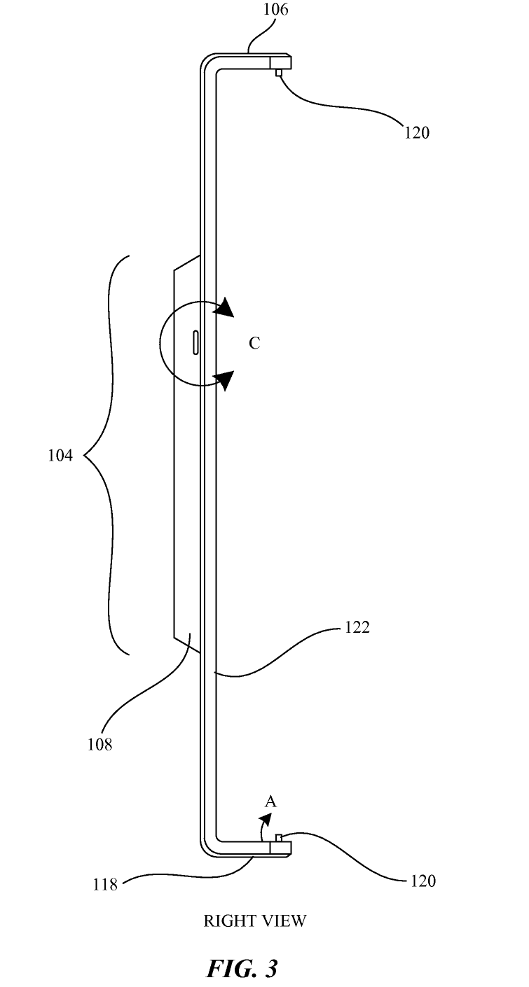

The mounting portion 104 further comprises a cable channel 112. In the embodiment shown in FIG. 1 and FIG. 3, the cable channel 112 is formed by a discontinuity of the mounting flange 108 at an end of the mounting portion 104. The cable channel 112 allows access to a portion of a motion capture device for attaching a power and/or data cable to a motion capture device when the motion device is in attached to the adapter 100. The mounting flange 108 further includes one or more indicate light ports 114 configured to allow indicator lights on portions of a motion capture device covered by the mounting flange 108 to be visible when the motion capture device is attached to the adapter 100.

At the ends of the main body of the adapter are first and a second opposing flanged ends 116 and 118. On the inner surface of each end 116 and 118 are one or more retaining clips 120 configured to couple to a feature of the HMD in order to secure the adapter 100 to the HMD. The main body 102, flanged ends 116 and 118, retaining clips 120, or any combination therefore are configured to be resilient enough to allow the flanged ends and retaining clips to spread apart from each other, yet rigid enough to hold the adapter in place when the retaining clips 120 are engaged with a feature of the HMD.

To attach an adapter to an HMD the adapter is positioned so that outer edges of the HMD contact the retaining clips. The adapter and HMD are pressed together causing the retaining clips and the flanged edges to spread apart and flex outward allowing the adapter to slide onto the HMD. The adapter slides onto the HMD until the retaining clips engage with a feature of the HMD and cause the adapter to spring back so that the flanged ends and retaining clips are no longer spread apart. In embodiments, the retaining clips are configured to engage with air vents on side surfaces of an HMD. The retaining clips may be configured so that there is only one possible position and orientation that the adapter may be attached to the HMD. The retaining clips may be configured so that there is more than one possible position and orientation that the adapter may be attached to the HMD.

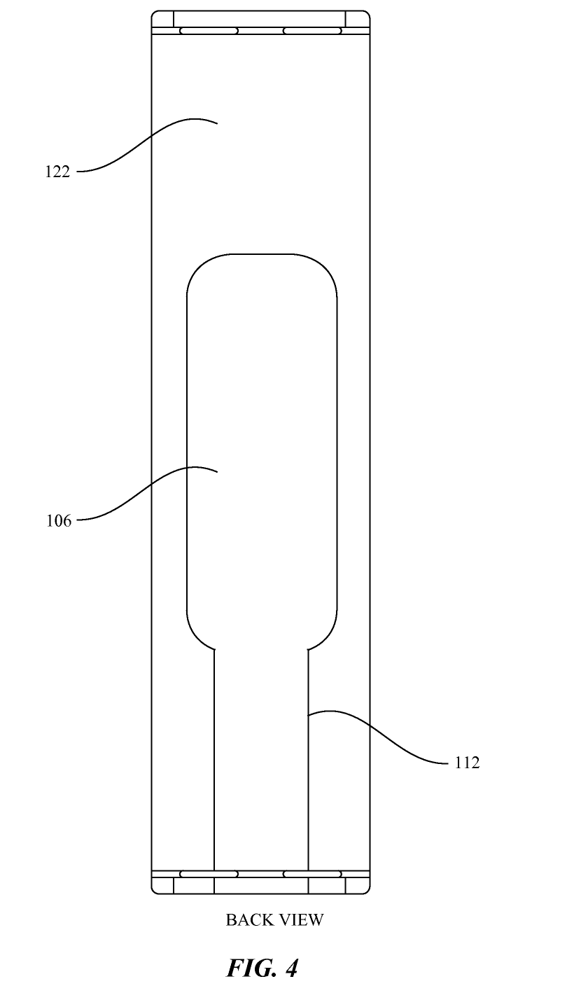

As shown in FIG. 3 and FIG. 4, the main body is generally flat on the rear side 122. When the adapter 100 is attached to an HMD, or other device, portions of the flat rear side 122 may be in direct contact with a surface of an HMD. The main body of the adapter may be curved, have curved surfaces, or have surface features configured to be complementary to surface features of a surface of an HMD.

In embodiments, the adapter includes guide mechanisms configured to align and maintain alignment of the adapter in a particular orientation with respect to the HMD. The guide mechanism may include guide features, the flanged ends 116 and 118, the retention clips 120, the rear side 122 or any combination thereof. A single adapter may be configured to be coupled to more than one type device, for example two differently designed HMDs or an HMD and a tablet.

In embodiments, the adapter may be configured to have one or more openings to expose sensors or emitters located on a surface of the HMD. For example the HMD may include radiation emitters such as infrared LEDs that are detected by an external motion sensing device. To accommodate the radiation emitters, the adapter may include openings configured to allow the LEDs to emit radiation in a similar way as if the adapter and motion capture device were not attached to the HMD. Further, the adapter may be configured so that the no sensors or emitters are covered by the adapter when the adapter is attached to the HMD. Further, the adapter may be constructed of materials that do not affect the operation of sensors or emitters of the HMD that are covered by the adapter.

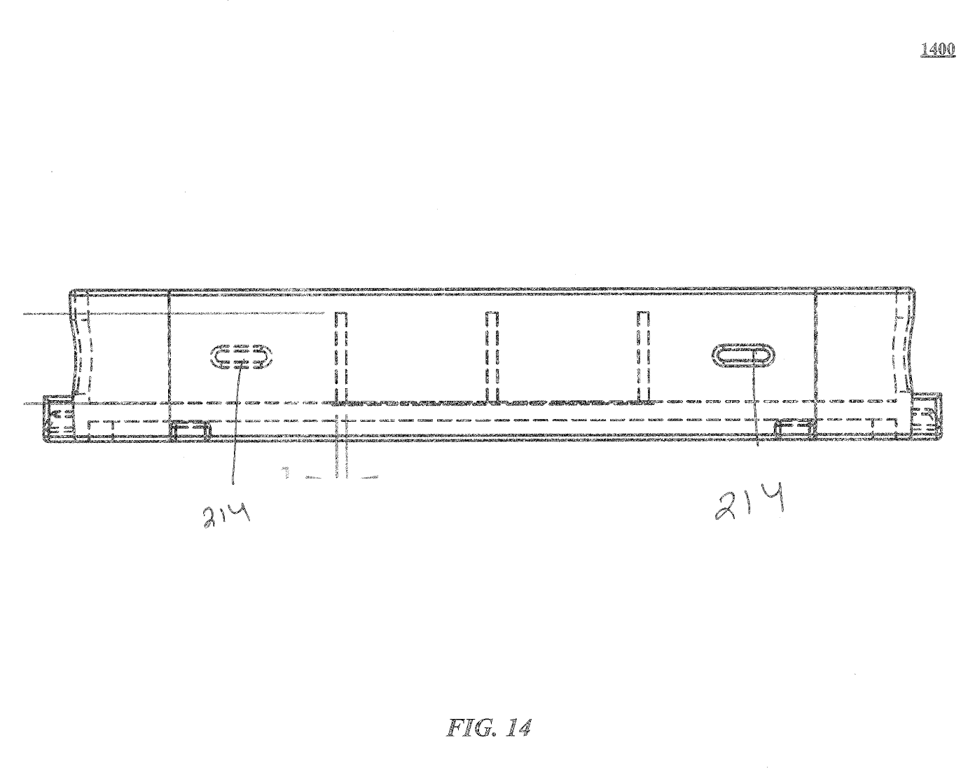

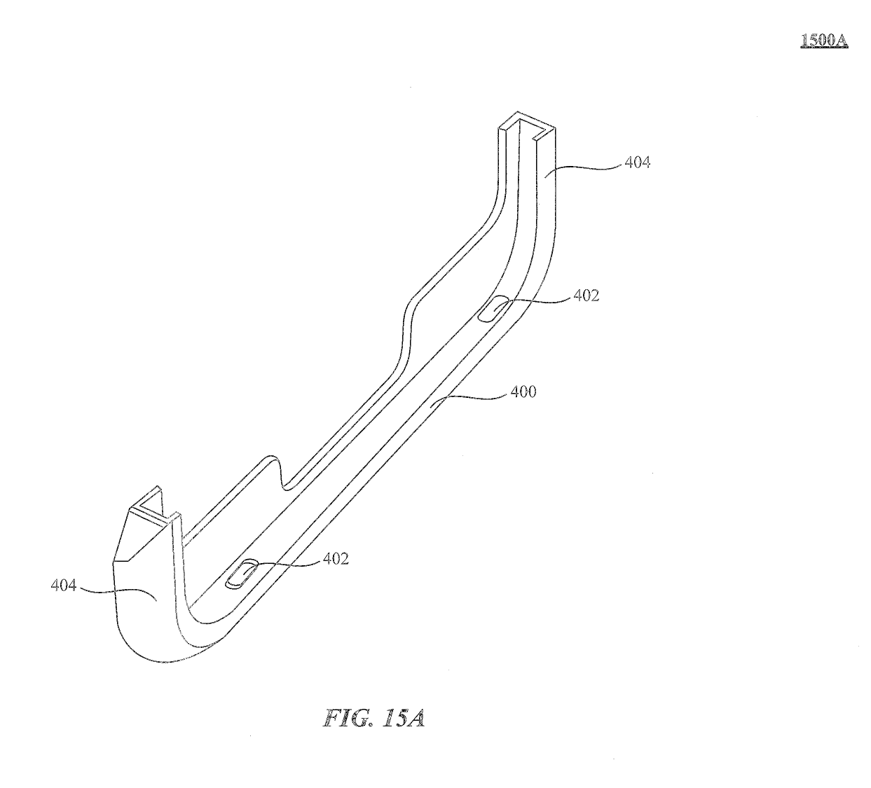

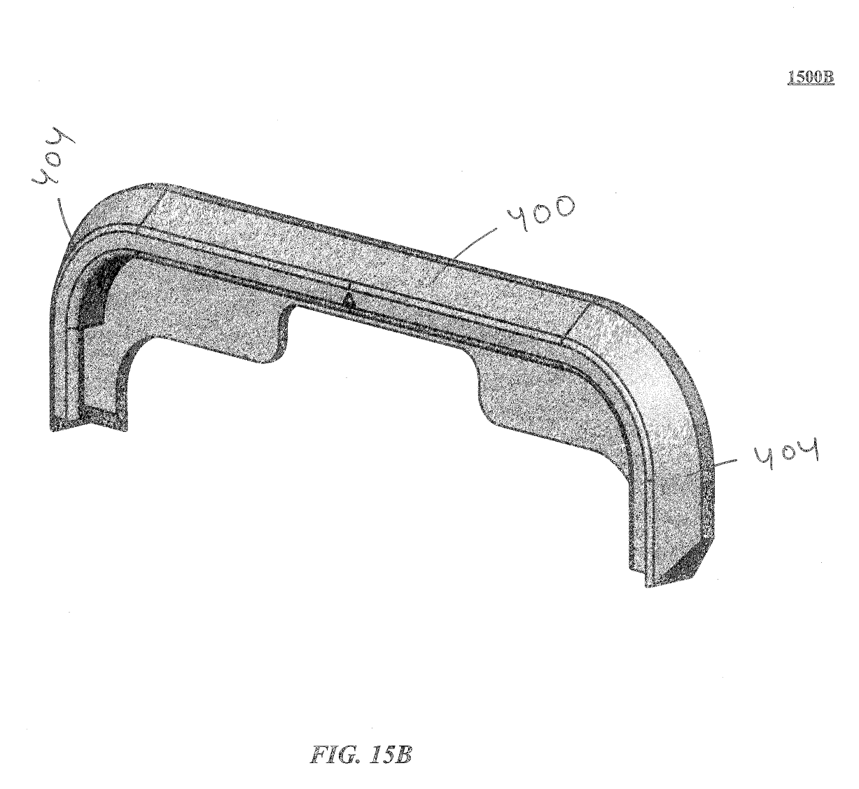

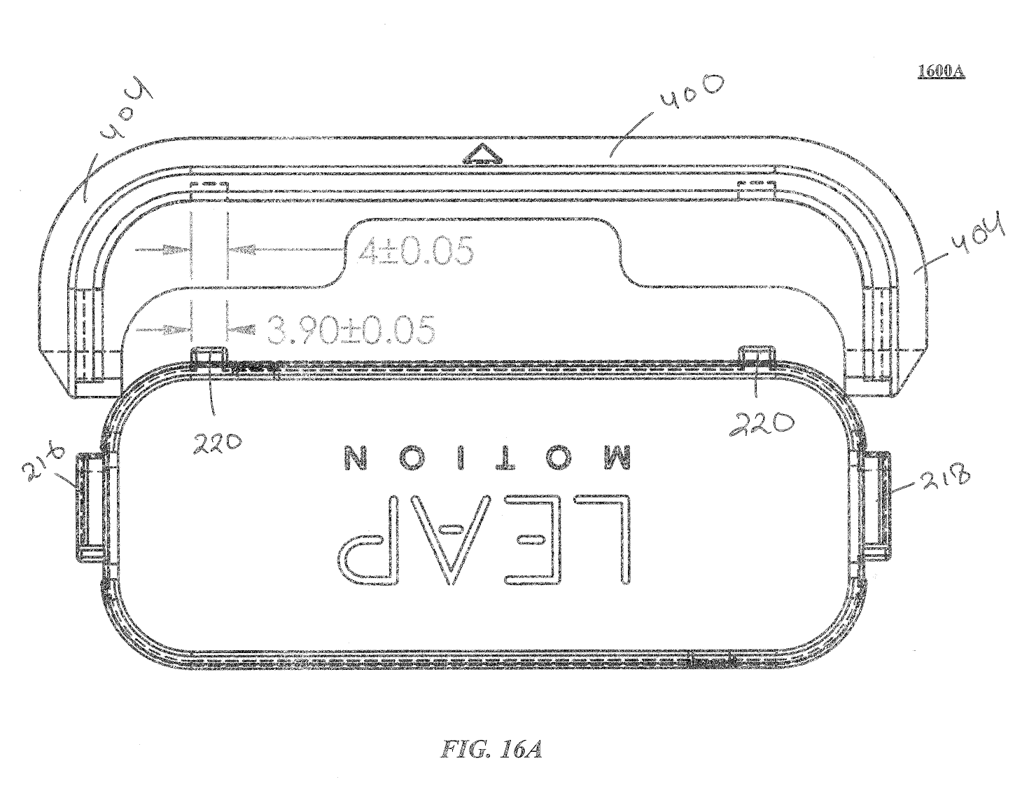

FIG. 11 is a perspective view 2200 of another implementation of an adapter 200 in left-right orientation, in accordance with the technology disclosed. FIG. 12 is a perspective view 2200 of the adapter 200 shown in FIG. 11 in right-left orientation, in accordance with the technology disclosed. FIG. 13 is a front view 1300 of the adapter 200 shown in FIG. 11 in accordance with the technology disclosed. FIG. 14 is a side view 1400 of the adapter 200 shown in FIG. 11 in accordance with the technology disclosed.

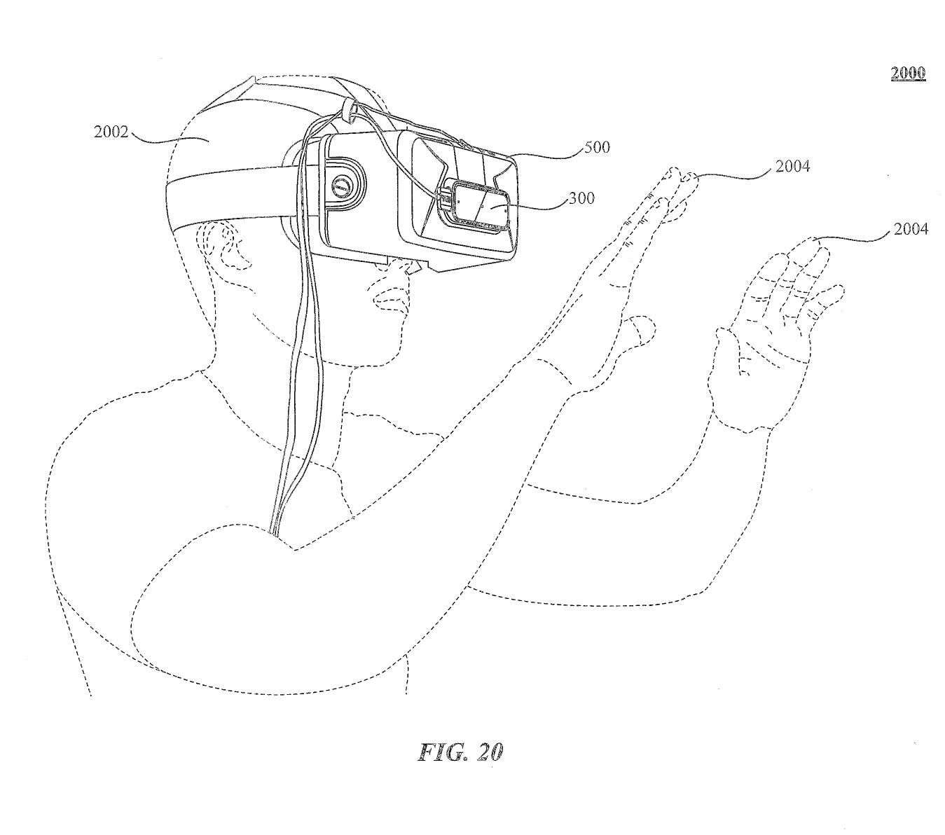

Referring to FIGS. 11 and 12, an adapter 200 is illustrated. The adapter 200 includes a main body portion 202. The main body portion 202 includes a mounting portion 204. The mounting portion 204 comprises an opening 206 configured to receive and secure a motion capture device 300 (show in FIG. 17). The mounting portion 204 further comprises a mounting flange 208 on the top surface of the main body located around the perimeter of the opening 206. The mounting flange 208 includes an inner surface 210 configured to provide a secure friction fit with an outer perimeter of a motion capture device 300 creating a friction fit or compression fit. In embodiments, other attachment mechanisms for securing the motion capture device 300 to the adapter are envisioned including magnets, clips, adhesives, etc. The mounting portion 204 may be configured to receive a motion capture device 300 through the rear portion of the main body, the front portion of the main body or both. The mounting portion 204 may be configured to accommodate various motion capture devices with different form factors.

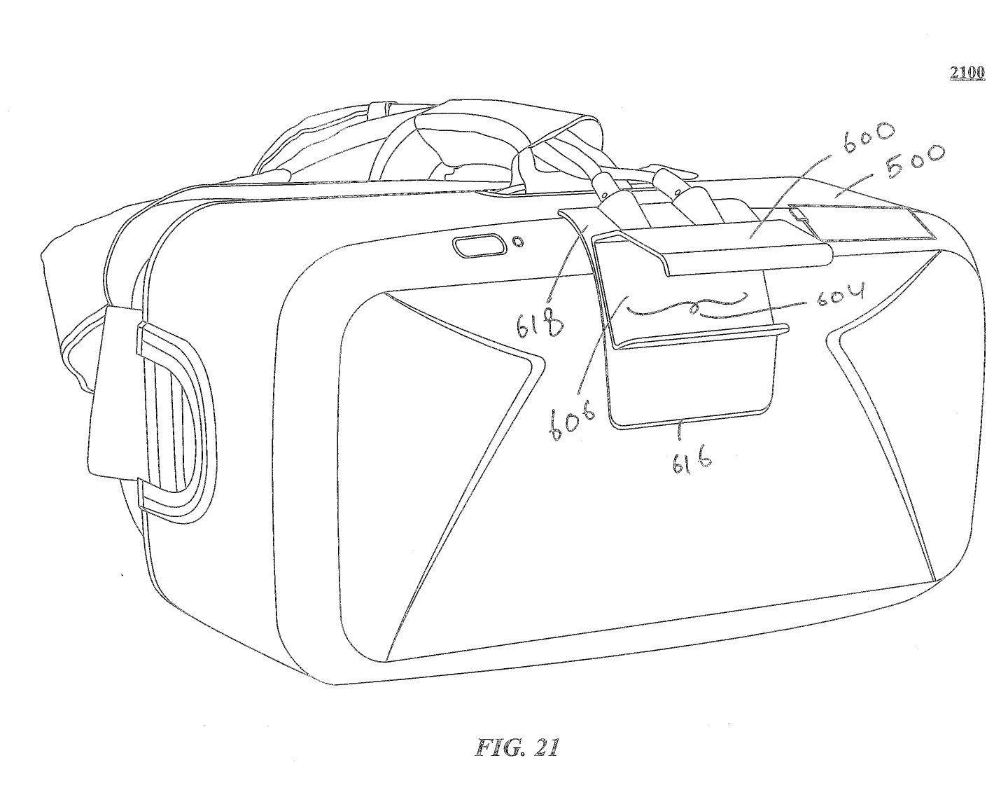

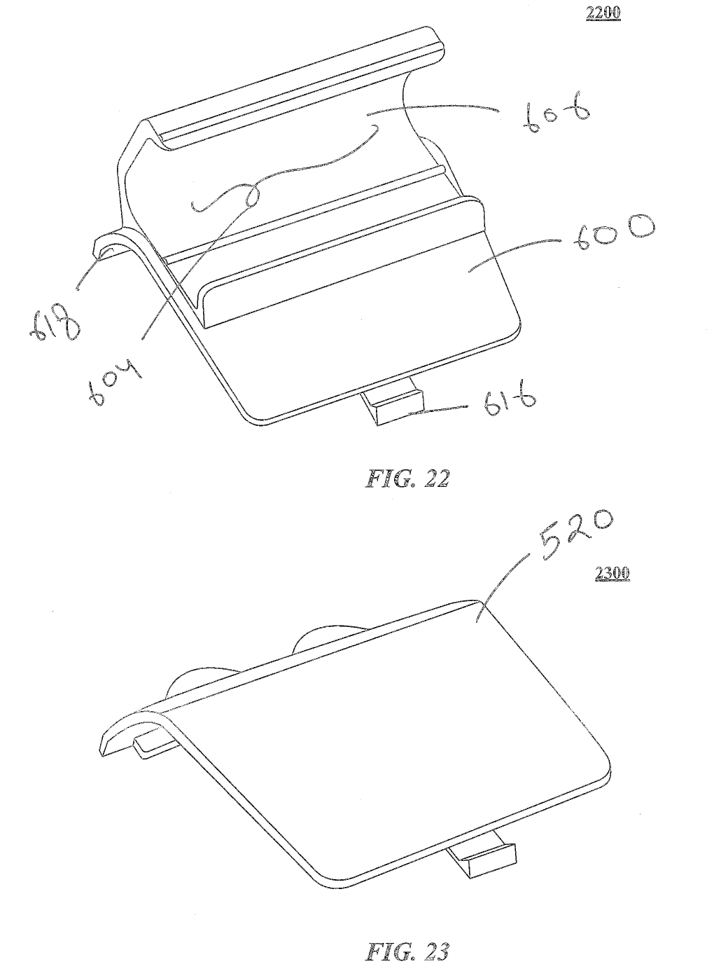

The mounting portion 204 further comprises a cable channel 212. In the embodiment shown in FIG. 11, the cable channel 212 is formed by a discontinuity of the mounting flange 108 at an end of the mounting portion 204. The cable channel 212 allows access to a portion of a motion capture device 300 for attaching a power and/or data cable 302 to a motion capture device 300 when the motion device 300 is in attached to the adapter 200, as shown in FIGS. 18 and 19. At the ends of the main body of the adapter 200 are first and a second opposing flanged ends 216 and 218. The mounting flange 208 further includes one or more indicate light ports 214 configured to allow indicator lights on portions of a motion capture device 300 covered by the mounting flange 208 to be visible when the motion capture device 300 is attached to the adapter 200.

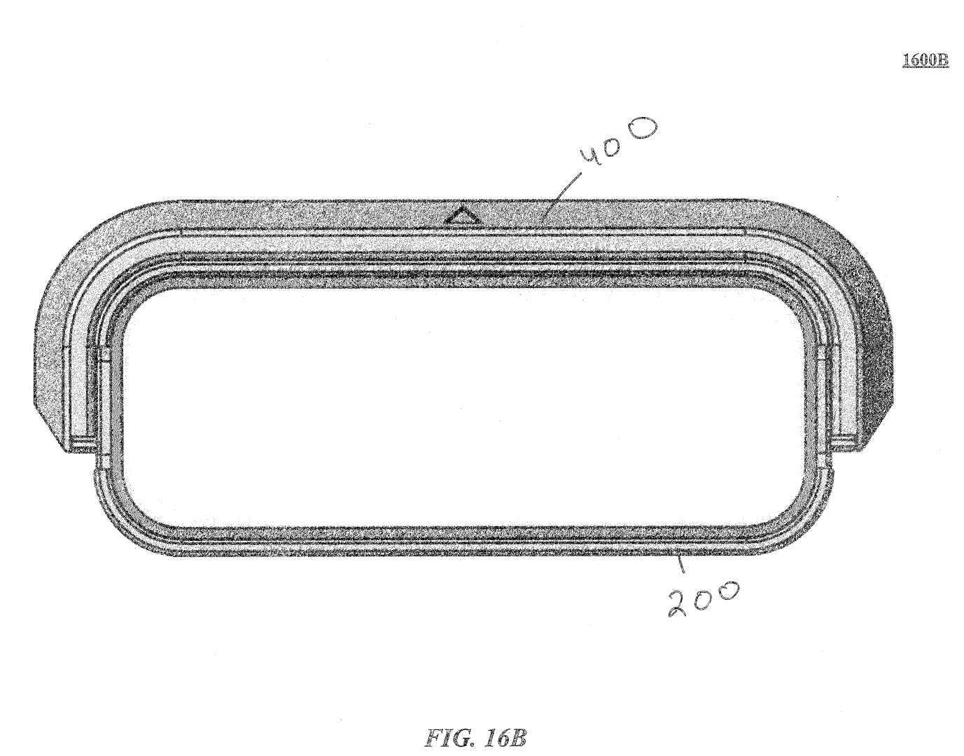

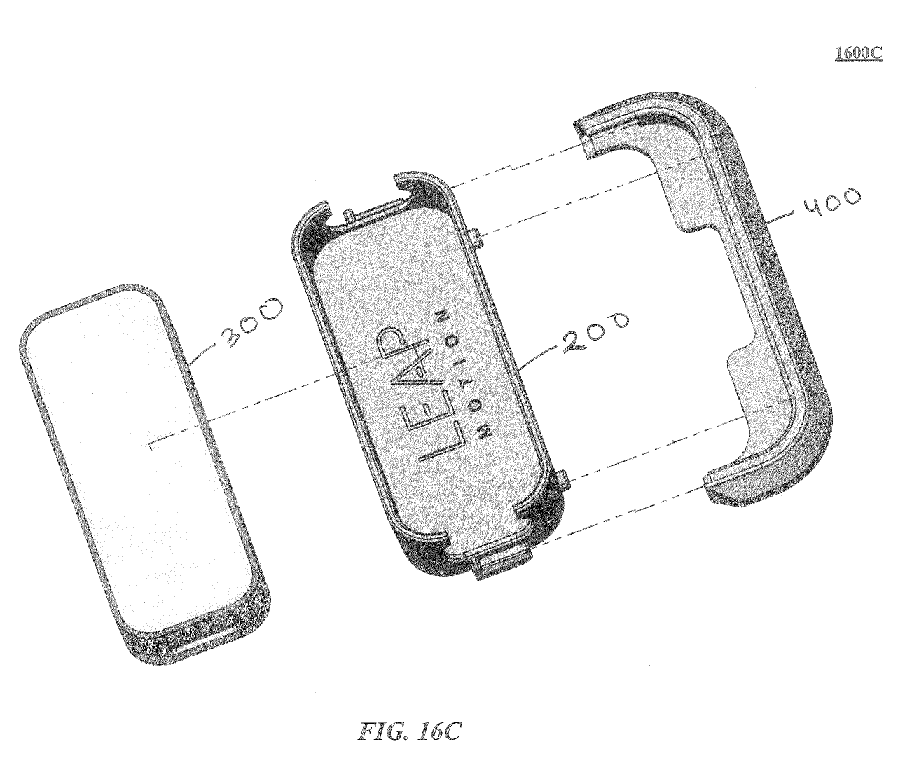

FIG. 15A is a perspective view 1500A of an adapter plate 400, in an upright orientation, that attaches to an HMD 500 and receives an adapter 200 in accordance with the technology disclosed.

FIG. 15B is a perspective view 1500B of an adapter plate 400, in an upside down orientation, that attaches to an HMD 500 and receives an adapter 200 in accordance with the technology disclosed.

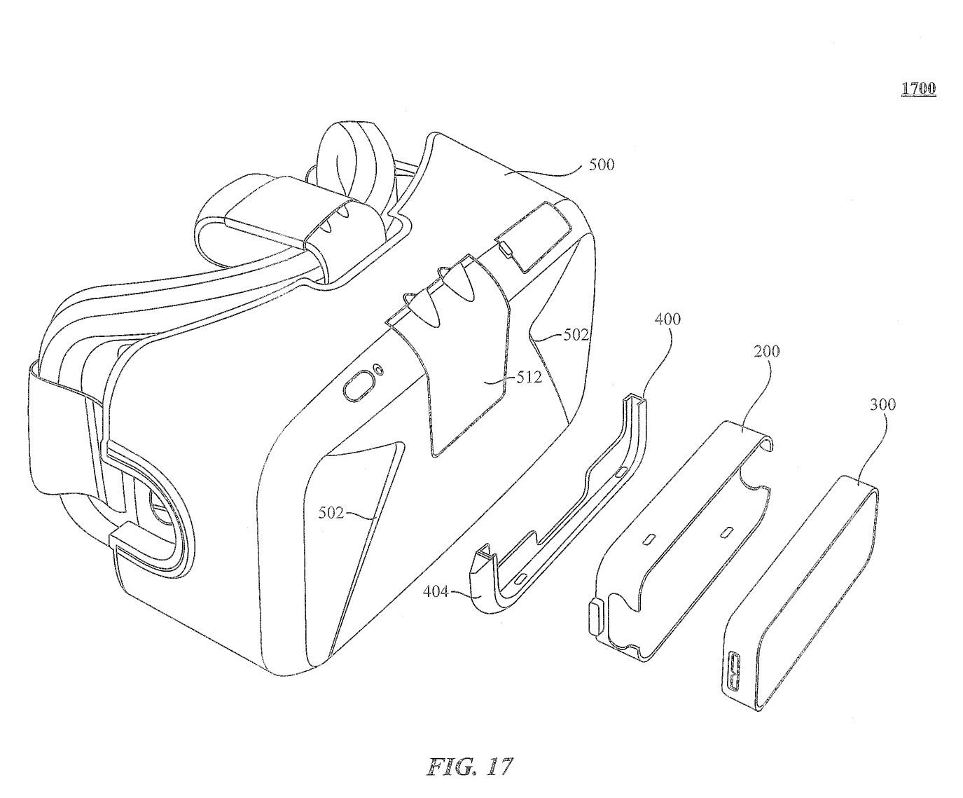

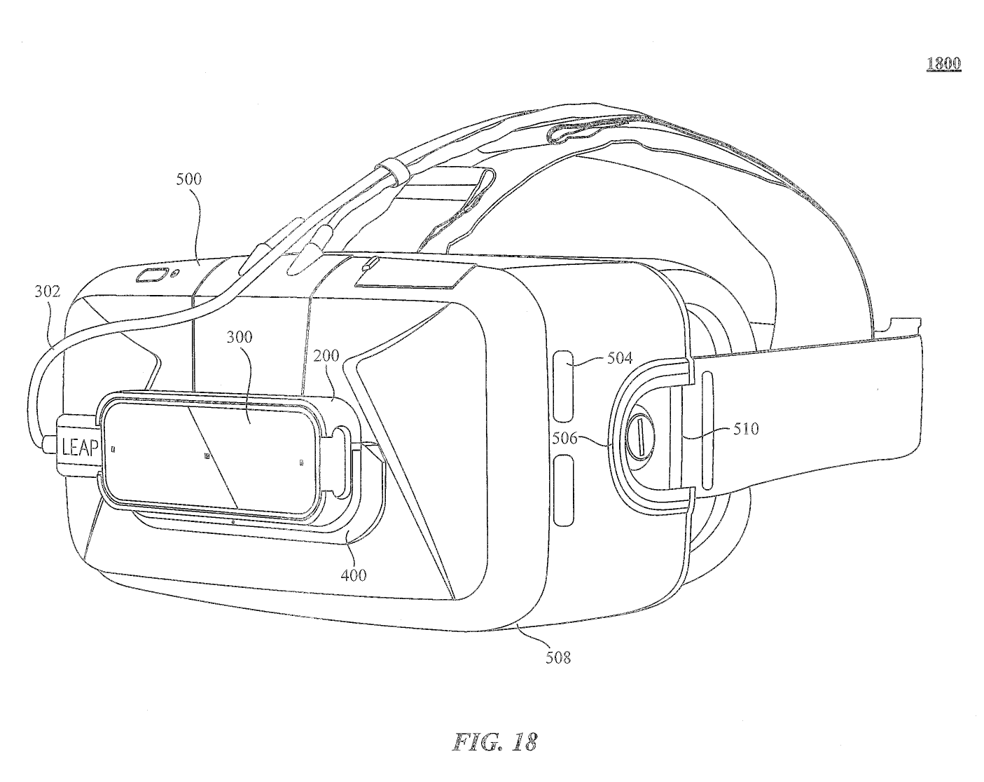

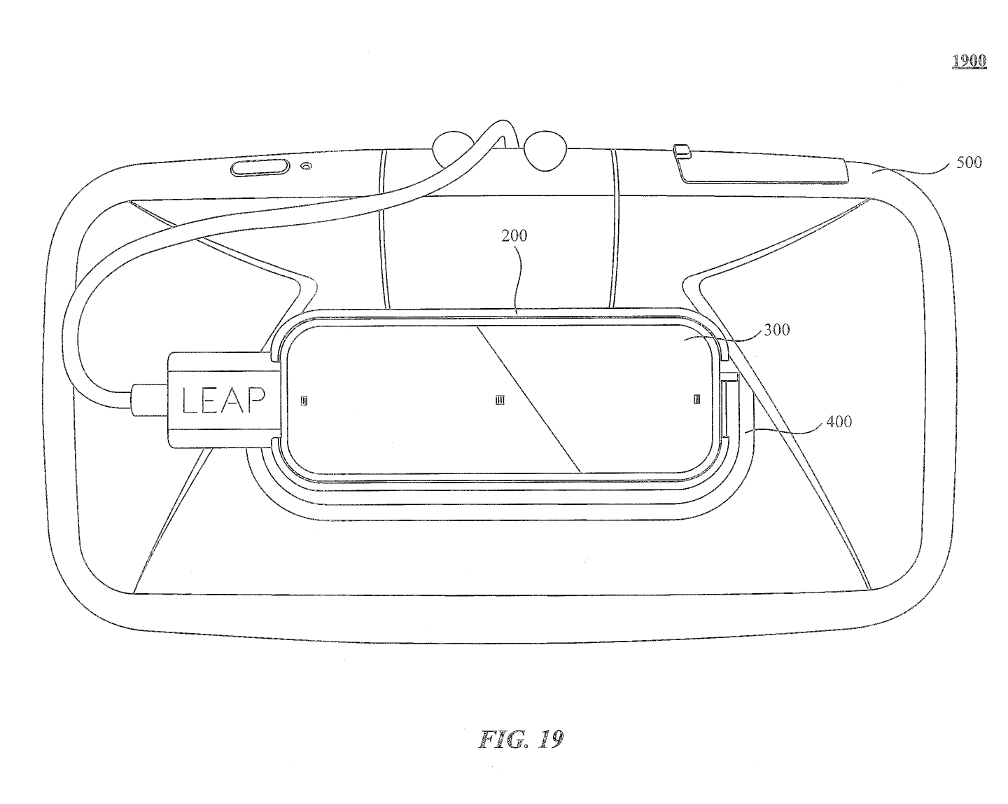

FIG. 16A is a perspective view 1600A of the adapter plate 400 receiving the adapter 200 in accordance with the technology disclosed.

FIG. 16B is a front view 1600B of an adapter plate 400 attached to an adapter 200 in accordance with the technology disclosed.

FIG. 16C is a perspective view 1600C of a motion capture device 300 being secured in an adapter 200 that is received by an adapter plate 400 in accordance with the technology disclosed.

On the outer surface of the bottom mounting flange 208 are one or more retaining clips 220 configured to couple to a feature of the HMD 500 in order to secure the adapter 200 to the HMD 500. In one implementation, the retaining clips 220 are configured to couple to an adapter plate 400 attached to the HMD 500 using at least one of magnets, clips, adhesives, etc. The retaining clips 220 engage with the adapter plate 400 through openings 402 in the adapter plate 400. In embodiments, the main body portion 202 may comprise a recess or cavity operable to selectively encapsulate the adapter plate 400. In other embodiments, the adapter plate 400 may comprise a recess or cavity operable to selectively encapsulate the main body portion 202.

To engage an adapter plate 400 to an adapter 200, the adapter 200 is positioned so that the recessed inner edges 406 of the adapter plate 400 receive the flanged ends 216 and 218 of the adapter 200. The adapter plate 400 and adapter 200 are pressed together causing the retaining clips 208 of the adapter 200 to enter openings 402 of the adapter plate 400 allowing adapter 200 to slide onto the adapter plate 400. The adapter 200 slides onto the adapter plate 400 until the recessed inner edges 406 receive the flanged ends 216 and the retaining clips 220 fit into the openings 402. The retaining clips 220 may be configured so that there is only one possible position and orientation that the adapter 200 may be fitted into the adapter plate 400. The retaining clips 208 may be configured so that there is more than one possible position and orientation that the adapter 200 may be fitted into the adapter plate 400.

FIG. 17 is a perspective view 1700 of attaching a motion capture device 300 to an HMD 500 via an adapter plate 400 and an adapter 200 in accordance with the technology disclosed.

To attach motion capture device 300 to an HMD 500, the adapter plate 400 can be fasten to the HMD 500 using an adhesive, according to one implementation. In one example, the angled sides 404 of adapter plate 400 are aligned with the angled details 502 of HMD 500. Further, adapter 200 is engaged with the adapter plate 400 using flanged ends 216 and 218 and retaining clips 220. Once adapter 200 is fasten to the HMD 500 via the adapter plate 400, motion capture device 300 is placed in the mounting portion 204. In other implementations, motion capture device 300 is secured with adapter 200 before adapter 200 is attached to the HMD 500 via the adapter plate 400.

FIG. 18 is a perspective view 1800 of a motion capture device 300 attached to an HMD 500 via an adapter plate 400 and an adapter 200 in accordance with the technology disclosed. FIG. 19 is a front view 1900 of a motion capture device 300 attached to an HMD 500 via an adapter plate 400 and an adapter 200 in accordance with the technology. In other implementations, motion capture device 300 is operable to be attached to or detached from the adapter 200, and the adapter 200 is operable to be attached to or detached from HMD 500 via the adapter plate 400. The motion capture device 300 is attached to the HMD 500 with an adapter 200 in a fixed position and orientation. In embodiments, the attachment mechanism coupling the adapter to the HMD 500 utilizes existing functional or ornamental elements of an HMD. Functional or ornamental elements of the HMD 500 include; air vents 504, bosses, grooves, recessed channels 506, slots formed where two parts connect 508, openings for head straps 510, cord cover 512, etc. Advantageously by using existing features of the HMD 500 to attach the adapter 200, no modification to the design of the HMD 500 is needed to attach a motion capture device 300.

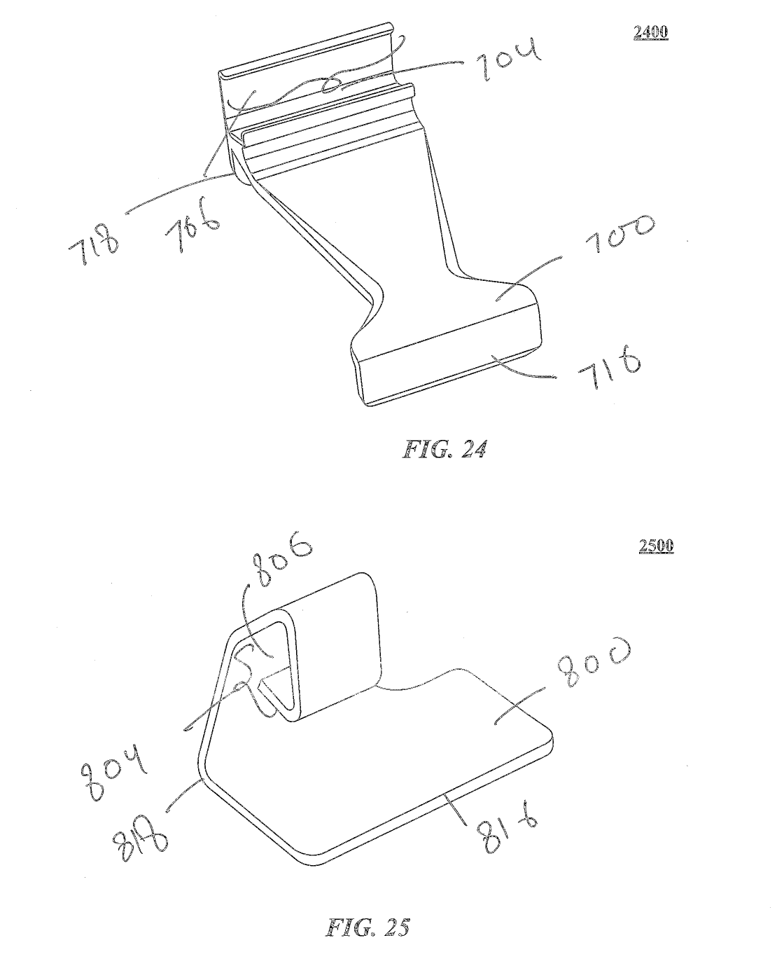

FIG. 20 is a perspective view 2000 of a motion capture device 300 coupled to an HMD 500 that enables gesture recognition while a user 2002 is wearing the HMD 500. In particular, FIG. 20 shows that user 2002 is interacting with a virtual reality/augmented reality application using gestures performed by hands 2004. In one implementation, motion capture device 300 includes wide-angled lenses that extend beyond stereo displays of HMD 500, thereby tracking the hands 2004 before user 2002 is able to see them via HMD 500.

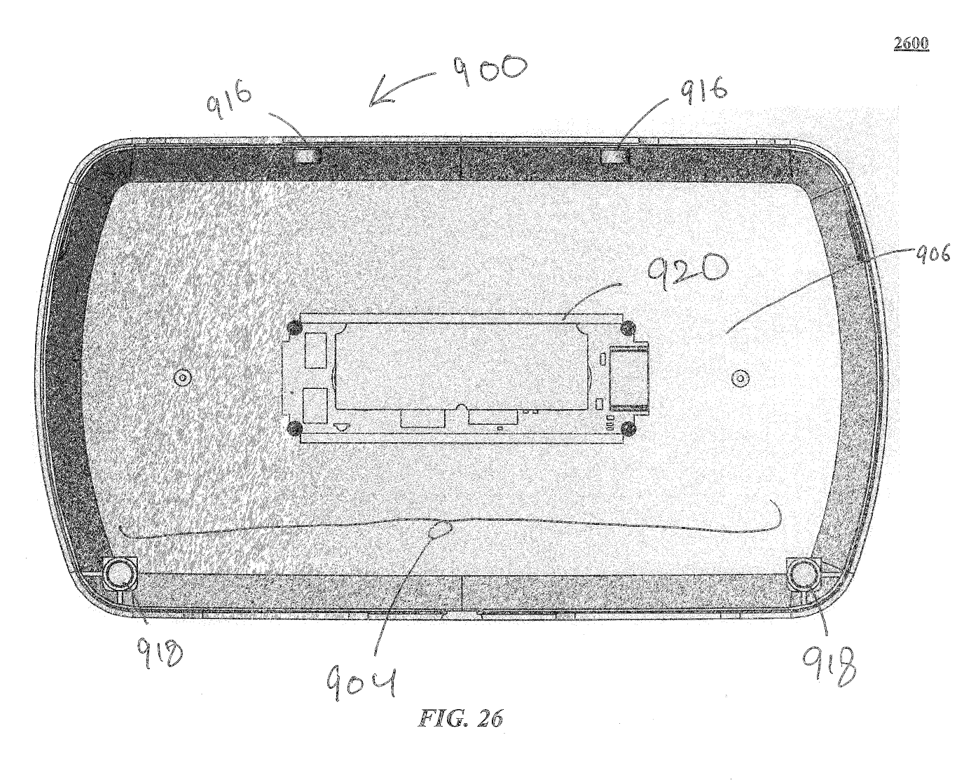

FIG. 21 is a perspective view 2100 of another implementation of an adapter 600 attached to an HMD 500. Adapter 600 is used to mount Nimble's motion sensor.

The adapter 600 includes a main body portion. The main body portion includes a mounting portion 604. The mounting portion 604 comprises an opening 606 configured to receive and secure a motion capture device. The mounting portion 604 further comprises a mounting flange on the top surface of the main body located around the perimeter of the opening 606. The mounting flange includes an inner surface configured to provide a secure friction fit with an outer perimeter of a motion capture device creating a friction fit or compression fit. In embodiments, other attachment mechanisms for securing the motion capture device to the adapter are envisioned including magnets, clips, adhesives, etc. The mounting portion 604 may be configured to receive a motion capture device through the rear portion of the main body, the front portion of the main body or both. The mounting portion 604 may be configured to accommodate various motion capture devices with different form factors.

At the ends of the main body of the adapter 600 are first and a second opposing flanged ends 616 and 618. On the inner surface of each end 616 and 618 can be one or more retaining clips configured to couple to a feature of the HMD in order to secure the adapter 600 to the HMD. The main body, flanged ends 616 and 618, retaining clips, or any combination therefore are configured to be resilient enough to allow the flanged ends and retaining clips to spread apart from each other, yet rigid enough to hold the adapter in place when the retaining clips are engaged with a feature of the HMD.

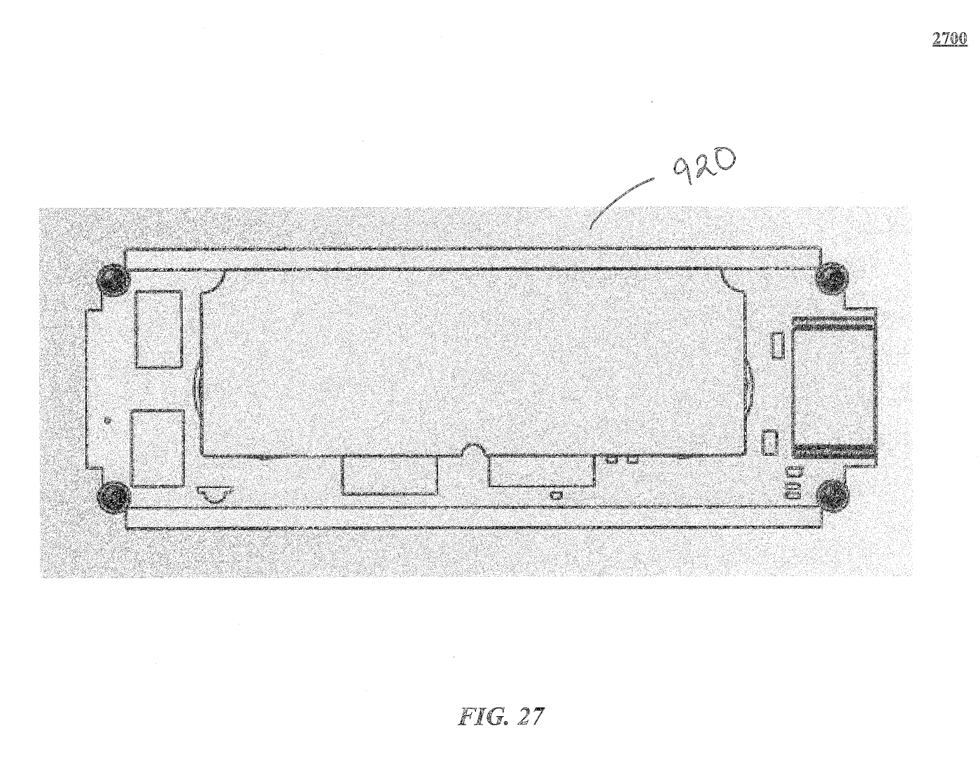

FIG. 22 is a perspective view 2200 of the adapter 600 shown in FIG. 21.

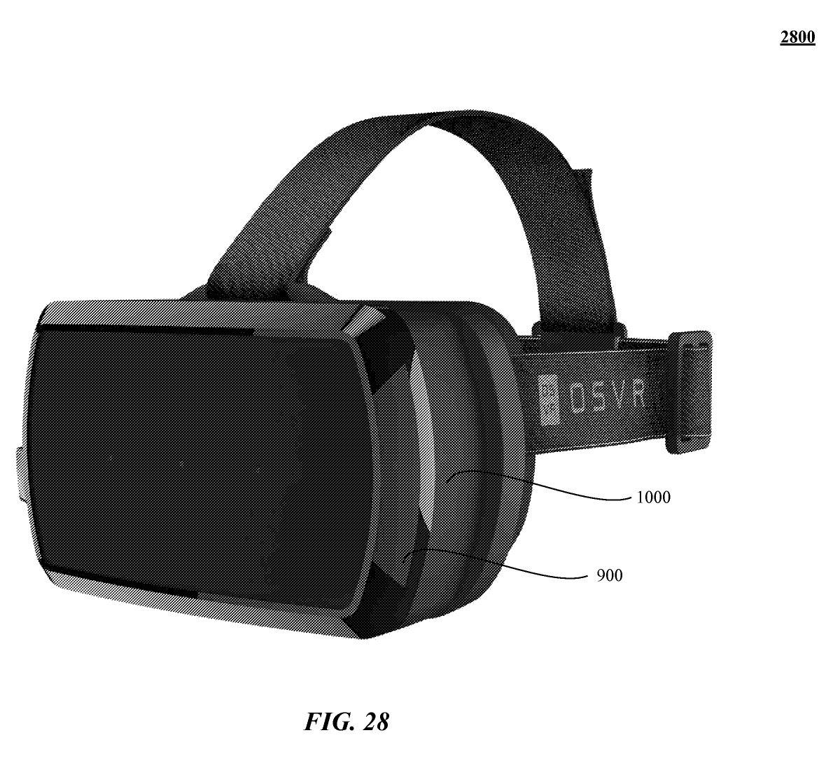

FIG. 23 is a perspective view 2230 of a cord cover 520 of an HMD 500 that is replaced to attach an adapter to the HMD 500.

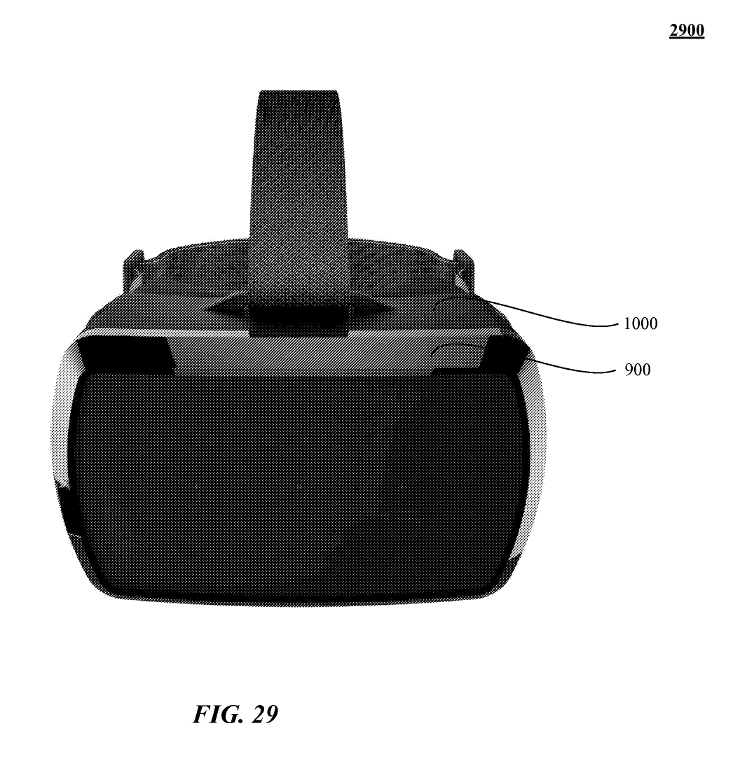

FIG. 24 is a perspective view 2400 of another implementation of an adapter 700 used to attach a motion capture device to an HMD. Adapter 700 is used to mount Nimble's motion sensor.

The adapter 700 includes a main body portion. The main body portion includes a mounting portion 704. The mounting portion 704 comprises an opening 706 configured to receive and secure a motion capture device. The mounting portion 704 further comprises a mounting flange on the top surface of the main body located around the perimeter of the opening 706. The mounting flange includes an inner surface configured to provide a secure friction fit with an outer perimeter of a motion capture device creating a friction fit or compression fit. In embodiments, other attachment mechanisms for securing the motion capture device to the adapter are envisioned including magnets, clips, adhesives, etc. The mounting portion 704 may be configured to receive a motion capture device through the rear portion of the main body, the front portion of the main body or both. The mounting portion 704 may be configured to accommodate various motion capture devices with different form factors.

At the ends of the main body of the adapter 700 are first and a second opposing flanged ends 716 and 718. On the inner surface of each end 716 and 718 can be one or more retaining clips configured to couple to a feature of the HMD in order to secure the adapter 700 to the HMD. The main body, flanged ends 716 and 718, retaining clips, or any combination therefore are configured to be resilient enough to allow the flanged ends and retaining clips to spread apart from each other, yet rigid enough to hold the adapter in place when the retaining clips are engaged with a feature of the HMD.

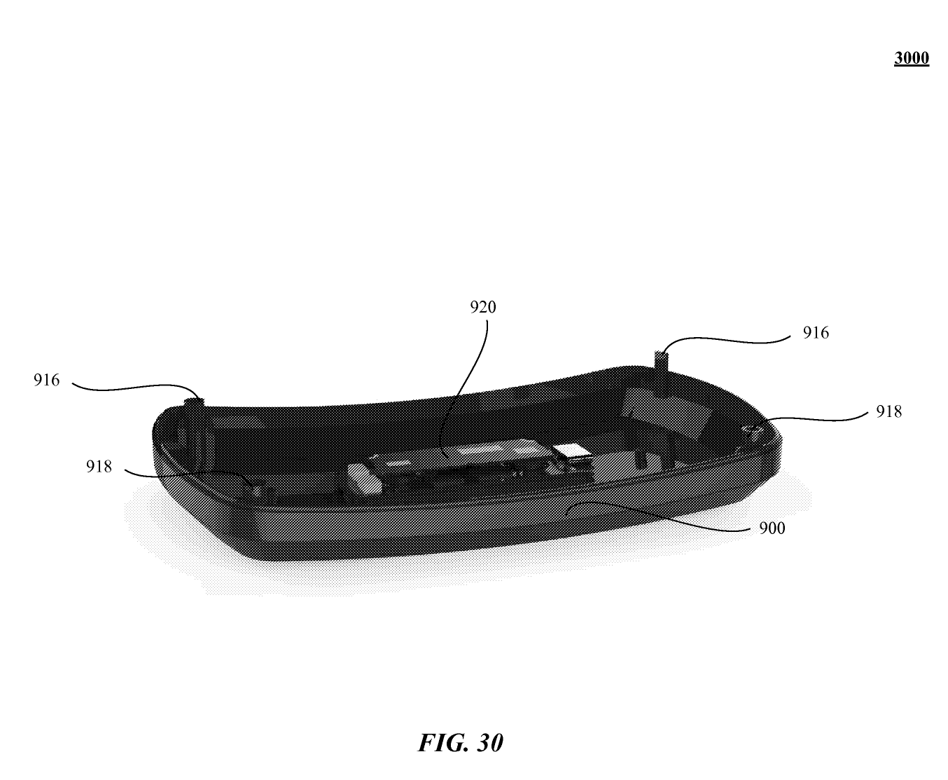

FIG. 25 is a perspective view 2500 of yet another implementation of an adapter 800 used to attach a motion capture device to an HMD. Adapter 800 is provided by a gesture tracking company called Nimble.

The adapter 800 includes a main body portion. The main body portion includes a mounting portion 804. The mounting portion 804 comprises an opening 806 configured to receive and secure a motion capture device. The mounting portion 804 further comprises a mounting flange on the top surface of the main body located around the perimeter of the opening 806. The mounting flange includes an inner surface configured to provide a secure friction fit with an outer perimeter of a motion capture device creating a friction fit or compression fit. In embodiments, other attachment mechanisms for securing the motion capture device to the adapter are envisioned including magnets, clips, adhesives, etc. The mounting portion 804 may be configured to receive a motion capture device through the rear portion of the main body, the front portion of the main body or both. The mounting portion 804 may be configured to accommodate various motion capture devices with different form factors.

At the ends of the main body of the adapter 800 are first and a second opposing flanged ends 816 and 818. On the inner surface of each end 816 and 818 can be one or more retaining clips configured to couple to a feature of the HMD in order to secure the adapter 800 to the HMD. The main body, flanged ends 816 and 818, retaining clips, or any combination therefore are configured to be resilient enough to allow the flanged ends and retaining clips to spread apart from each other, yet rigid enough to hold the adapter in place when the retaining clips are engaged with a feature of the HMD.

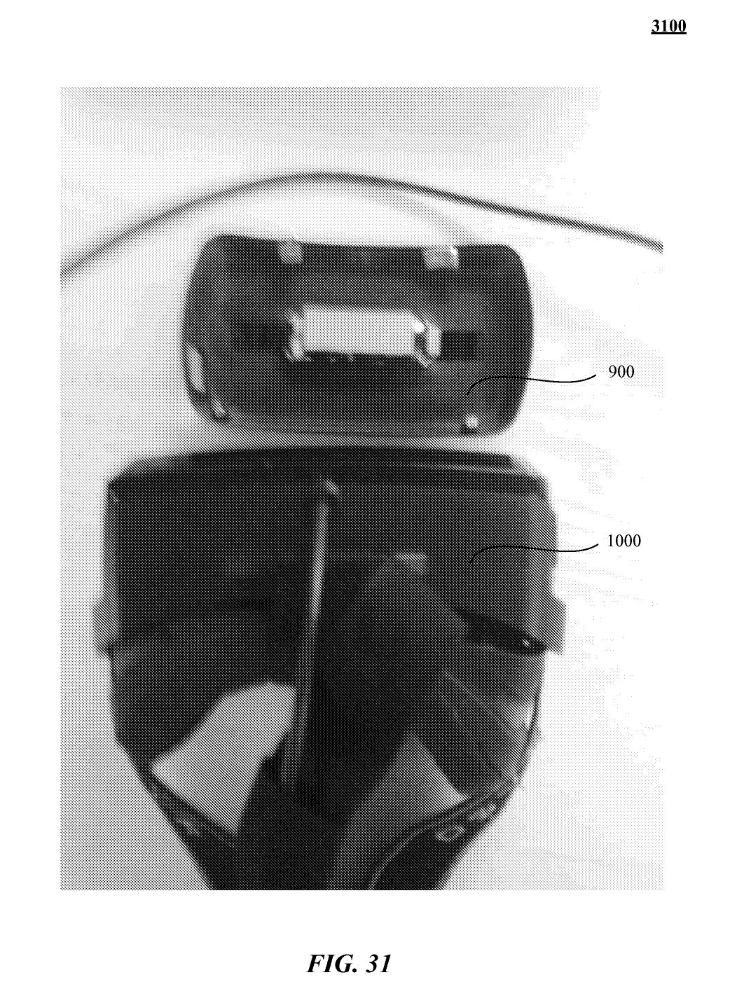

FIG. 26 is a perspective view 2600 of yet another implementation of an adapter 900 used to attach a motion capture device 920 to an HMD.

Adapter 900 is provided by Leap Motion, Inc.

The adapter 900 includes a main body portion. The main body portion includes a mounting portion 904. The mounting portion 904 comprises an opening 906 configured to receive and secure a motion capture device 920. The mounting portion 904 further comprises a mounting flange on the top surface of the main body located around the perimeter of the opening 906. The mounting flange includes an inner surface configured to provide a secure friction fit with an outer perimeter of a motion capture device 920 creating a friction fit or compression fit.

In embodiments, other attachment mechanisms for securing the motion capture device to the adapter are envisioned including magnets, clips, adhesives, etc. The mounting portion 904 may be configured to receive a motion capture device 920 through the rear portion of the main body, the front portion of the main body or both. The mounting portion 904 may be configured to accommodate various motion capture devices with different form factors.

At the ends of the main body of the adapter 900 are first and a second opposing flanged ends 916 and 918. On the inner surface of each end 916 and 918 can be one or more retaining clips configured to couple to a feature of the HMD in order to secure the adapter 900 to the HMD. The main body, flanged ends 916 and 918, retaining clips, or any combination therefore are configured to be resilient enough to allow the flanged ends and retaining clips to spread apart from each other, yet rigid enough to hold the adapter in place when the retaining clips are engaged with a feature of the HMD.

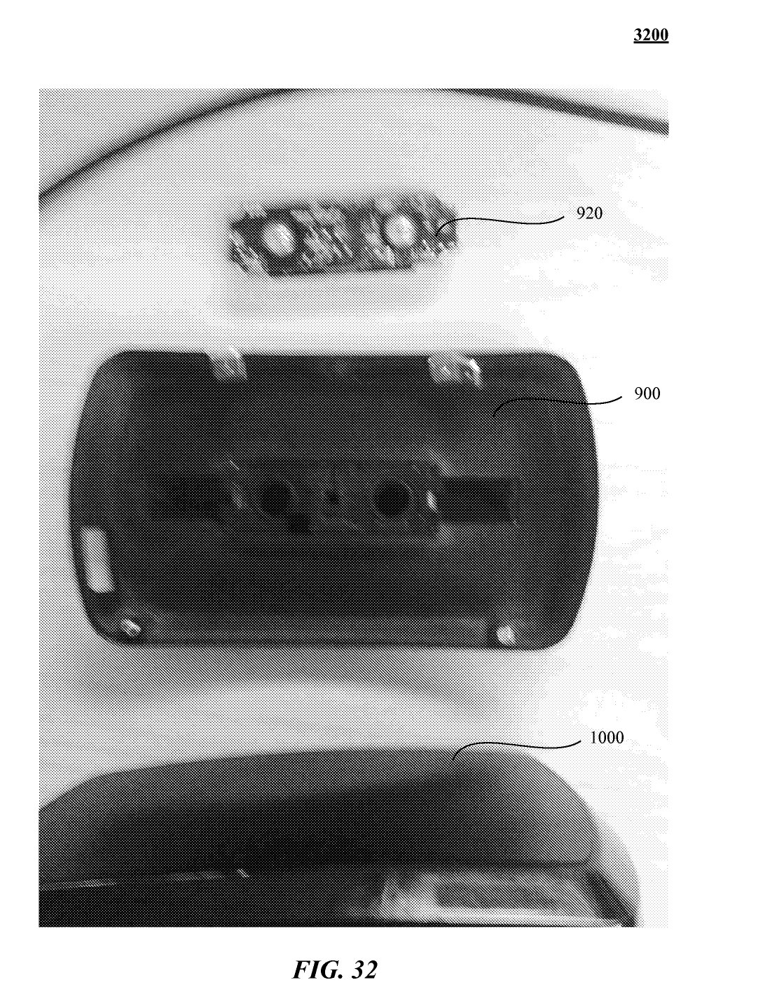

FIG. 27 is a perspective view 2700 of a motion capture device 920 secured in an adapter 900 shown in FIG. 26.

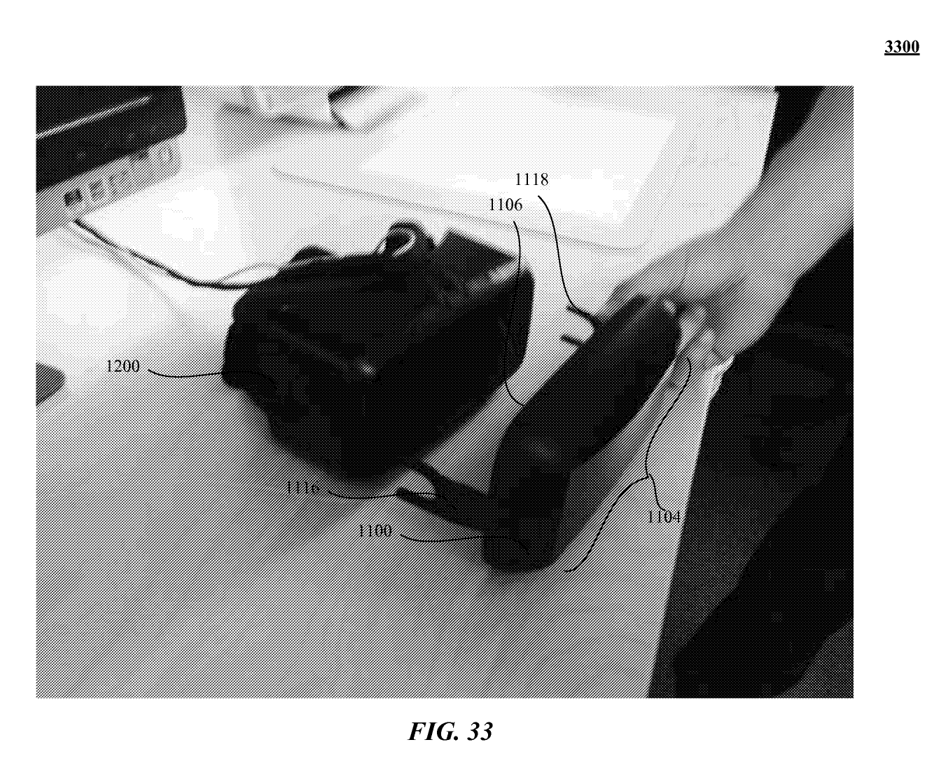

FIG. 28 is a perspective view 2800 of an HMD 1000 with an attached motion capture device 920 using adapter 900.

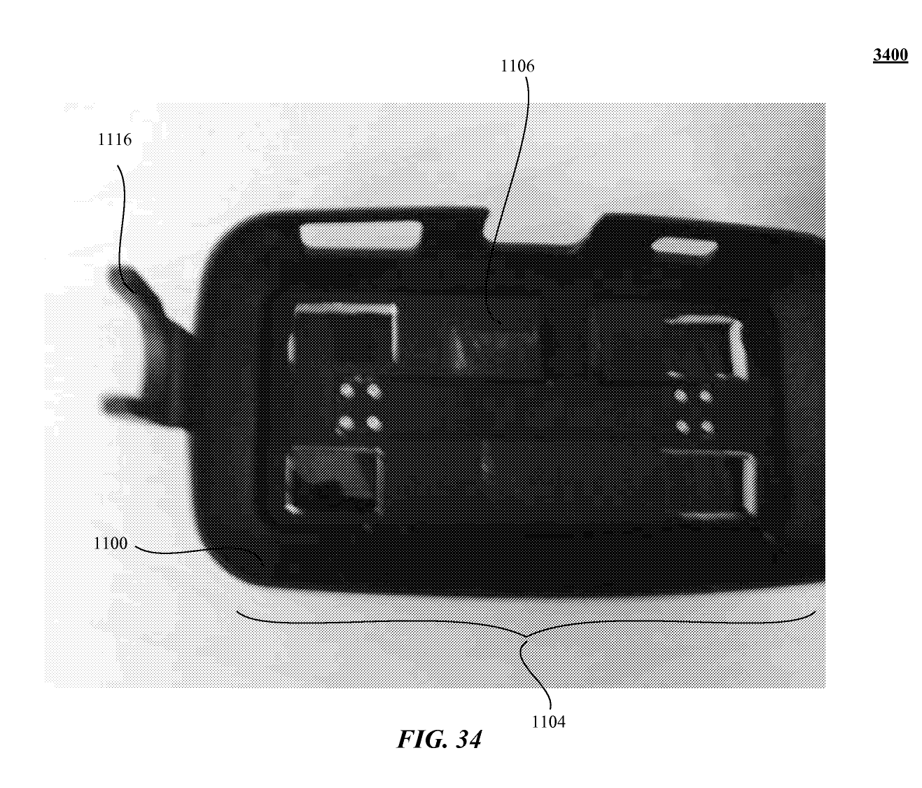

FIG. 29 is a front view 2900 of an HMD 1000 with an attached motion capture device 920 using adapter 900.

FIGS. 31-32 are real world images 3000, 3100, and 3200 of an adapter shown in FIG. 26 that is attached to an HMD.

Adapter 900 is provided by Leap Motion, Inc.

In particular, adapter 900 includes a main body portion, a motion capture device mounted to the main body portion and a pair of opposing flanged ends on opposite sides of the main body portion and least one retaining clip located on each flanged end configured to be received by detents on surfaces of the head mounted display. In other implementations, the flanged ends can be replaced by bosses or grooves that serve the same purposes of engaging with a feature of the HMD.

The adapter 900 includes a main body portion. The main body portion includes a mounting portion 904. The mounting portion 904 comprises an opening 906 configured to receive and secure a motion capture device 920. The mounting portion 904 further comprises a mounting flange on the top surface of the main body located around the perimeter of the opening 906. The mounting flange includes an inner surface configured to provide a secure friction fit with an outer perimeter of a motion capture device 920 creating a friction fit or compression fit. In embodiments, other attachment mechanisms for securing the motion capture device to the adapter are envisioned including magnets, clips, adhesives, etc. The mounting portion 904 may be configured to receive a motion capture device 920 through the rear portion of the main body, the front portion of the main body or both. The mounting portion 904 may be configured to accommodate various motion capture devices with different form factors.

At the ends of the main body of the adapter 900 are first and a second opposing flanged ends 916 and 918. On the inner surface of each end 916 and 918 can be one or more retaining clips configured to couple to a feature of the HMD in order to secure the adapter 900 to the HMD. The main body, flanged ends 916 and 918, retaining clips, or any combination therefore are configured to be resilient enough to allow the flanged ends and retaining clips to spread apart from each other, yet rigid enough to hold the adapter in place when the retaining clips are engaged with a feature of the HMD.

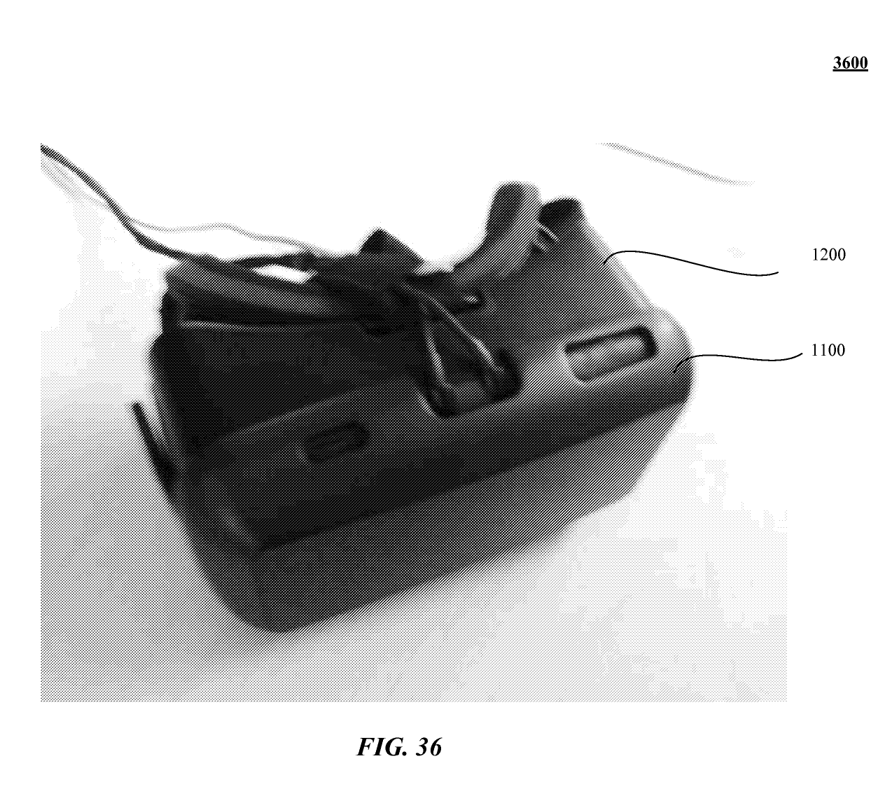

FIGS. 33-36 are real world images 3300, 3400, 3500, and 3600 of yet another implementation of an adapter 1100 that is attached to an HMD 1200.

Adapter 1100 is provided by Leap Motion, Inc.

In particular, adapter 1100 includes a main body portion a motion capture device mounted to the main body portion and two or more retaining clips configured to be received by detents on surfaces of the head mounted display. In other implementations, the flanged ends can be replaced by bosses or grooves that serve the same purposes of engaging with a feature of the HMD.

The adapter 1100 includes a main body portion. The main body portion includes a mounting portion 1104. The mounting portion 1104 comprises an opening 1106 configured to receive and secure a motion capture device. The mounting portion 1104 further comprises a mounting flange on the top surface of the main body located around the perimeter of the opening 906. The mounting flange includes an inner surface configured to provide a secure friction fit with an outer perimeter of a motion capture device creating a friction fit or compression fit. In embodiments, other attachment mechanisms for securing the motion capture device to the adapter are envisioned including magnets, clips, adhesives, etc. The mounting portion 1104 may be configured to receive a motion capture device through the rear portion of the main body, the front portion of the main body or both. The mounting portion 1104 may be configured to accommodate various motion capture devices with different form factors.

At the ends of the main body of the adapter 1100 are first and a second opposing flanged ends 1116 and 1118. On the inner surface of each end 1116 and 1118 can be one or more retaining clips configured to couple to a feature of the HMD in order to secure the adapter 1100 to the HMD. The main body, flanged ends 1116 and 1118, retaining clips, or any combination therefore are configured to be resilient enough to allow the flanged ends and retaining clips to spread apart from each other, yet rigid enough to hold the adapter in place when the retaining clips are engaged with a feature of the HMD.

Thus, although the disclosed technology has been described with respect to specific implementations, it will be appreciated that the disclosed technology is intended to cover all modifications and equivalents with the scope of the following claims.

1. A device for attaching a motion capture device to a head mounted display comprising:
a main body portion including an opening that is configured to removably receive and hold the motion capture device;
a pair of opposing flanged ends on opposite sides of the main body portion; and
at least one retaining clip located on each flanged end configured to be received by detents on surfaces of the head mounted display.

2. The device of claim 1, wherein the detents are air vents on opposite sides of the head mounted display.

3. The device of claim 1, wherein the main body portion comprises a mounting flange configured to create a friction fit with the motion capture device.

4. The device of claim 3, wherein the mounting flange includes a channel that allows for insertion of a power or data cable into the motion capture device.

5. The device of claim 1, wherein the main body portion comprises at least one aperture configured to allow a radiation emitter on a surface of the head mounted display covered by the main body to emit radiation through the main body portion.

6. The device of claim 1, wherein the main body portion is configured to receive adapter plates that attach the motion capture device to the head mounted display.

7. The device of claim 1, wherein the detents are bosses on the head mounted display.

8. The device of claim 1, wherein the detents are grooves on the head mounted display.

9. The device of claim 1, wherein the detents are recessed channels on the head mounted display.

10. The device of claim 1, wherein the detents are slots formed where two parts of the head mounted display connect.

11. The device of claim 1, wherein the detents are openings for head straps of the head mounted display.

12. The device of claim 1, further including attaching the motion capture device to the head mounted display using adhesives.

13. The device of claim 1, further including attaching the motion capture device to the head mounted display using magnets.

14. The device of claim 1, wherein the main body portion is curved.

15. The device of claim 1, wherein the main body portion includes curved surfaces.

16. The device of claim 1, wherein the main body portion includes surface features configured to be complementary to surface features of a surface of the head mounted display.

17. A device for attaching a motion capture device to a head mounted display comprising:
a main body portion including an opening that is configured to removably receive and hold the motion capture device, wherein the main body portion is configured to receive adapter plates that attach the motion capture device to the head mounted display;
a pair of opposing flanged ends on opposite sides of the main body portion; and
at least one retaining clip located on each flanged end configured to be received by detents on surfaces of the head mounted display.

18. A device for attaching a motion capture device to a head mounted display comprising:
a main body portion including an opening that is configured to removably receive and hold the motion capture device;
a pair of opposing flanged ends on opposite sides of the main body portion and at least one retaining clip located on the main body portion; and
at least one adapter plate attached to the head mounted display and configured to receive the flanged ends and the retaining clip.

19. A device for attaching a motion capture device to a head mounted display comprising:
a main body portion;
a motion capture device mounted to the main body portion; and
a pair of opposing flanged ends on opposite sides of the main body portion; and
least one retaining clip located on each flanged end configured to be received by detents on surfaces of the head mounted display.

20. A device for attaching a motion capture device to a head mounted display comprising:
a main body portion;
a motion capture device mounted to the main body portion; and
two or more retaining clips configured to be received by detents on surfaces of the head mounted display.
